(19) United States
(12) Patent Application Publication
(10) Pub. No.: US 2003/0028489 A1
(43) Pub. Date: Feb. 6, 2003

(54) Method and apparatus for legitimate sharing of electronic content

(76) Inventor: Matthew Murray Williamson, Bristol (GB)

Correspondence Address: HEWLETT-PACKARD COMPANY, Intellectual Property Administration, P.O. Box 272400, Fort Collins, CO, 80527-2400, US

(21) Appl. No.: 10/201,232

(22) Filed: Jul. 22, 2002

(30) Foreign Application Priority Data
Jul. 31, 2001 (GB) 0118581.8

(51) Int. Cl. G06F 17/60

(52) U.S. Cl. 705/59

(57) ABSTRACT

A method of distributing electronic content including metadata for that content comprises the following: reading the metadata to identify the content; identifying a holder of the copy; determining if the metadata includes licence data and whether the holder of the copy is a licensee; and, if not, receiving payment for that copy of said content so that said holder becomes an owner or licensee of said content. New licence data is then provided for inclusion in the metadata of that copy of the content to identify the holder as a licensee of said content.

### FIELD OF THE INVENTION

This invention relates to a method and apparatus for at least encouraging legitimate sharing of electronic content, such as electronically stored music or literary works, for example.

### BACKGROUND TO THE INVENTION

The commercial distribution of electronic content, such as electronically stored music or literary works, for example, traditionally takes place through retail outlets, such as record or book shops. Commercial distribution of electronic content over an information technology network has many advantages, but has not yet been widely adopted by creators and commercial distributors of such content, largely because of fears relating to the resultant increase in potential ease with which such content may be illicitly reproduced, sold and distributed by third parties. For this reason, significant effort has been directed toward the development of technological safeguards which prevent unauthorised copying of electronic content. Traditionally, however, it has been found that any technological measure which prevents unauthorised copying is ultimately defeatable by parties who wish to produce pirate copies, which means that new technological safeguards must continually be developed and introduced.

Digital content is relatively easy to copy illegally, which is both advantageous and disadvantageous for content providers in the sense that on the one hand it is desirable for the content to be distributed as widely as possible (thereby increasing its value and therefore the potential revenues to be gained therefrom), but they still want to ensure that they are paid for each sale, i.e. they do not want piracy taking place. In order to prevent piracy, as stated above, the content providers are inclined towards the use of digital protection schemes (which are normally based on encryption techniques) which are a) difficult to use for consumers and restrict distribution, b) expensive to manage, and c) possibly undercut by free, illegal schemes which provide the same content with an easier user experience.

A number of systems have been released relatively recently, which search the internet, sites such as Napster, Internet Service Providers (ISP's), etc. for music tracks and compare stored music with a checksum (which is a unique identifier generated from the music tracks, which identifies both the music and the original source), so that music from a particular retailer can be detected. Such systems work by scanning the music stored on user's machines, and comparing it to the contents of a database of music signatures (identifiers), so that infringing users can be detected. Once infringing users are identified, they are immediately sent a message warning them to remove the infringing material from the network within 24 hours or be faced with having their account blocked. Such systems are also adapted to track down the IP addresses of the infringing users, so that a take-down notice can be sent directly to the user's ISP if necessary, which essentially creates an environment whereby the mere accusation of wrong-doing could cause users to begin losing their Internet access, thereby putting content owners in a very strong position on the Web.

This type of system does not, however, provide a method of differentiating between legitimately owned content from illegal content, as it just checks the music itself.

Another known protection scheme is defined in the Electronic Book Exchange specification which provides the concept of the attachment of a binding licence to electronic content, which licence defines the legitimate uses of the content to which it is attached and prevents unauthorised use thereof, such as copying and sharing it. This type of approach, however, is strongly motivated by technical protection, in the sense that the content is largely encrypted, which does not encourage a user to operate as part of an ad hoc sales force on behalf of the content provider.

A similar type of protection system is provided by the Microsoft Digital Media System in which electronic content is provided with a key, with a corresponding key being required to be obtained from an authorised key server before the user can play the content. Such a scheme is once again strongly motivated by technical protection, and as such suffers from the same disadvantages as mentioned above in connection with the EBX specification. In addition, the scheme is tightly bound to the user's player, in the sense that special equipment is required by the user if they wish to play content protected by this scheme.

EP-A-0977200 describes recording apparatus which performs a deteriorating process when copying electronic content from one storing unit to another, unless an accounting process (to remunerate the copyright owner) has first been completed. Licensee details maybe stored or accessed from a remote location, and such details may be updated as a result of a successful accounting process.

In general, many known digital rights management and protection schemes involve substantial encryption of material, making it difficult to copy, or difficult to play copied content. U.S. Pat. No. 6,138,119 describes techniques for defining, using and manipulating rights management data structures in which the concept of a secure digital container is used for safely and securely storing and transporting digital content. Such containers are tamper-resistant containers which can be used to package any kind of digital information such as, for example, text, graphics, executable software, audio and/or video. However, once again, the use of such digital containers limits the extent to which a user can share the content with other potential consumers, thereby limiting the otherwise extensive potential marketing network provided by individual owners of electronic content. Further, this type of arrangement is expensive to set up and manage, as well as being complicated and restrictive to operate, giving a poor user experience.

For the purposes of the present specification, it should be appreciated that unauthorised copying of electronic content may, broadly speaking, be put into two categories, namely large-scale reproduction of content by a relatively small number of people and/or organisations for commercial purposes, and small-scale reproduction of content by a large number of individuals for private consumption. The former activity is typically performed by organised criminal parties for commercial purposes, and it is therefore unlikely to be prevented by the continual introduction of increasingly complex technological measures, whereas the latter activity is of course primarily motivated by a desire to save money. A consequence of the motives for private copying is that with appropriate incentives, many people can be persuaded to acquire legal copies. An extreme example of this would be if such copies were available free of charge, as people would much rather own a legitimate copy of, for example, a record by one of their favourite performance artists than an illicit copy. Of course, this type of incentive is not a commercially viable proposition, but it does illustrate the fact that if appropriate incentives can be found and conveniently offered, while still remunerating the owner of the copyright in the electronic content, private illicit copying could be largely eradicated without having to resort to a solution based on the continual development of technological barriers to prevent copying (and, of course, the expense associated with such a strategy).

The present invention is intended to provide an improved approach to the issue of dealing with unauthorised copying of electronic content by members of the public.

### SUMMARY OF THE INVENTION

Thus, in accordance with a first aspect of the present invention, there is provided a method of distributing electronic content including digital data (metadata)defining or otherwise identifying said content, the method comprising the steps of:

a) reading the metadata included in a copy of electronic content to identify the content to which it relates;

b) obtaining data relating to the identity of a holder of said copy;

c) determining if said metadata includes licence data (or information identifying such licence data), which licence data relates to the identity of one or more owners or licensees of said content, and if such licence data (or information relating thereto) is determined to be included in said metadata, determining if said holder of said copy is identified therein as an owner or licensee of said content; and, if not:

d) determining if said holder is an owner or licensee of said content and, if not, receiving payment for said copy of said content such that said holder becomes an owner or licensee of said content; and

e) generating or obtaining new licence data for inclusion in said metadata of said copy of said content, said new licence data identifying said holder as an owner or licensee of said content.

The first aspect of the present invention also extends to apparatus for distributing electronic content including digital data (metadata) defining or otherwise identifying said content, the apparatus comprising a computing system programmed to:

a) read the metadata included in a copy of electronic content to identify the content to which it relates;

b) obtain data relating to the identity of a holder of said copy;

c) determine if said metadata includes licence data (or information identifying such licence data), which licence data relates to the identity of one or more owners or licensees of said content, and if such licence data (or information relating thereto) is determined to be included in said metadata to determine if said holder of said copy is identified therein as an owner or licensee of said content; and, if not, to determine if said holder is an owner or licensee of said content and, if not to receive payment for said copy of said content such that said holder becomes an owner or licensee of said content; and

d) generate or obtain new licence data for inclusion in said metadata of said copy of said content, said new licence data identifying said holder as an owner or licensee of said content.

In accordance with a second aspect of the present invention, there is provided a method of storing electronic content comprising the steps of recording said electronic content on a data storage medium, generating metadata identifying said content and storing said metadata on said data storage medium, said metadata including a storage area for storing licence data (or information relating to licence data) for identifying one or more users as owners or licensees of said content in such a way as to be capable of being altered, added to or replaced using the method or apparatus as defined above.

In accordance with a third aspect of the present invention, there is provided apparatus for distributing electronic content including digital data (metadata) defining or otherwise identifying said content, the apparatus comprising a computer system programmed to:

a) receive or obtain data identifying a piece of content;

b) receive or obtain data relating to the identity of a holder of a copy of said content;

c) obtain access to or store a licence bank comprising details of licences owned by each of a plurality of users, which licence bank can be searched to determine whether or not said holder owns a licence for said content;

d) provide, or direct a user to, a portal, by means of which new licences can be negotiated, agreed or issued as required;

e) update said licence bank in the event that a new licence is issued; and

f) provide details of said new licence for use in generating licence data to be written to the metadata of said copy of said content.

Also in accordance with the third aspect of the present invention, there is provided a method for distributing electronic content including digital data (metadata) defining or otherwise identifying said content, the method comprising the steps of:

a) providing a licence bank in which is stored details of licences owned by each of a plurality of users;

b) searching said licence bank to determine whether or not a specified user owns a licence for a particular piece of content;

c) providing, or directing a user to, a portal, by means of which new licences can be negotiated, agreed or issued as required;

d) updating said licence bank in the event that a new licence is issued; and

e) providing details of said new licence for use in generating licence data to be written to the metadata of said copy of said content.

In general, all three aspects of the invention have in common the fact that licence data can be written to (or replace existing licence data in) the metadata of a copy of electronic content. This means that such licence data can be dynamically added, deleted, altered or updated as required.

More specifically, the first aspect of the present invention covers two different situations. The first being whereby a first consumer is in possession of a first copy of a piece of content including metadata identifying first licence data indicating that the first consumer is a legitimate holder/user of the content, and the first consumer copies the content to produce a second copy (including in its metadata identification of the first licence data) and sends it to a second user. The metadata in the second copy identifies legitimate licence data but, because such licence data does not match with the identity of the second user (details of which have been sent to the commercial distributor or a party acting on their behalf), the commercial distributor can determine that it is a copy. Of course, the second user may already be an owner or licensee of the content in question (see below), but if he is not, he is given the opportunity to purchase the second copy. Once the commercial distributor has determined that the second user is already a licensee or has received payment for the second copy, the metadata in the second copy relating to the licence data is updated accordingly. The second situation being whereby a user simply copies electronic content from, for example, a compact disc or similar media, in the metadata of which copy there will be no licence data. As with the first aspect, the commercial distributor receives details identifying the content and the user, determines whether the user is already a licensee of the content and, if not, gives the user the opportunity to pay for the content. In the event that the user is already a licensee or payment is received for the copy, the commercial distributor transmits data to the user for inclusion in the metadata of the copy relating to licence data indicating the user as owner or licensee of the content.

The second aspect of the invention is concerned with the production of copies of electronic content having metadata to which licence data can be written; and the third aspect of the invention is concerned with the provision of a licence bank and portal for use in the method/apparatus of the invention.

In a preferred embodiment of the invention, one or more commercial distributors (or parties acting on their behalf) run a service comprising a contract bank for storing details of licences owned by each of a plurality of (preferably registered) users, and/or a portal via which new contracts can be negotiated and/or agreed and/or issued, as required. The licence bank and/or portal may be run on one or more servers, one or more of which may include or have access to a content store for storing a plurality of pieces of electronic content, each of the pieces of electronic content preferably being identified by a globally unique identifier. A record may be kept of all copies of electronic content for which licences have been issued.

In a preferred embodiment, the licence data is embedded in the metadata of the copy of the electronic content to which it relates, and comprises at least information identifying the licensee of that copy of the content and an identifier of a contract under which that copy of the content is owned. The method of the present invention preferably comprises the steps of checking all content files of one or more predetermined types stored on a first user's computer or similar digital storage means, reading any licence data included therein and sending it to the commercial distributor, and comparing said licence data against the contents of the licence bank to identify any discrepancies. In the event that a piece of content is identified, having licence data which is valid but relates to a second user, the invention preferably provides a means for offering the first user the opportunity to purchase a legitimate copy of the content. If the first user indicates his desire to do so, the invention preferably directs the user to a service portal or the like to negotiate/agree the terms of a licence, receive payment from the first user, and send details of the new licence to the licence bank. In a preferred embodiment of the invention, details of the content and the second user (who was the originator of the copy of the content just purchased by the first user) are at least temporarily retained, and the second user rewarded if the first user purchases a legitimate copy of the content.

It will be appreciated that the licence data referred to above may take many forms and be referenced in the metadata of a piece of electronic content in many different ways. In one, fairly restrictive embodiment, complete licence data (or a shortened version thereof) may be included in the metadata of a copy. Such licence data may take the form “Consumer A owns copy X of content Z”. In this case, updating data sent from the commercial distributor to a consumer of a second copy of the content would have the effect of changing the licence data to “Consumer B owns copy Y of content Z”.

However, this is a relatively cumbersome and restrictive process which requires substantial processing and storage capacity, as well as restricting the breadth of scope and flexibility which can be provided by certain types of licences. Thus, in a preferred embodiment of the present invention, a central licence bank is provided in which the licence itself is stored, the licence data being referenced in the metadata of a piece of content only by a unique identifier.

In the broadest terms, a contract is a mechanism by which permission is granted or authority is conferred, and such a mechanism can take many different forms and grant permission or confer authority for many different things and in many different ways. Thus, for example, a single contract could refer to one or more specific acts permitted to be performed by a single consumer in respect of a single piece or even copy of a piece of content. Another type of contract, may confer authority to a single consumer in respect of all copies of a piece of content, or even all copies of a number of pieces of (possibly related) content, for example, all albums by a particular artist. Alternatively, a consumer could have a single contract which details all of the content owned by that consumer, which contract is updated each time the consumer purchases another piece of content. It is even envisaged that certain groups of consumers could have permission granted thereto or authority conferred thereupon, perhaps upon payment of a subscription fee or fulfillment of certain requirements, say.

All of the above examples (and others not mentioned) are envisaged in connection with the present invention, and the present application is not intended to be limited in this respect.

The step of checking all content files of one or more predetermined types stored on a first user's computer may alternatively comprise transmitting a list of contracts owned by the first user to a content management means run by the first user's equipment, comparing the list against the content and contract data stored on the equipment, and identifying any discrepancies accordingly.

### BRIEF DESCRIPTION OF THE DRAWINGS

Embodiments of the present invention will now be described by way of examples only and with reference to the accompanying drawings, in which:

FIG. 1 is schematic representation of a commercial structure for the production and distribution of content to consumers;

FIG. 2 is a schematic illustration of the architecture of the storage of a commercial distributor, and the transmission of content to a consumer; and

FIG. 3 is a schematic illustration of a computer adapted to interact with electronic content distribution apparatus according to an exemplary embodiment of the present invention.

### DETAILED DESCRIPTION OF THE INVENTION

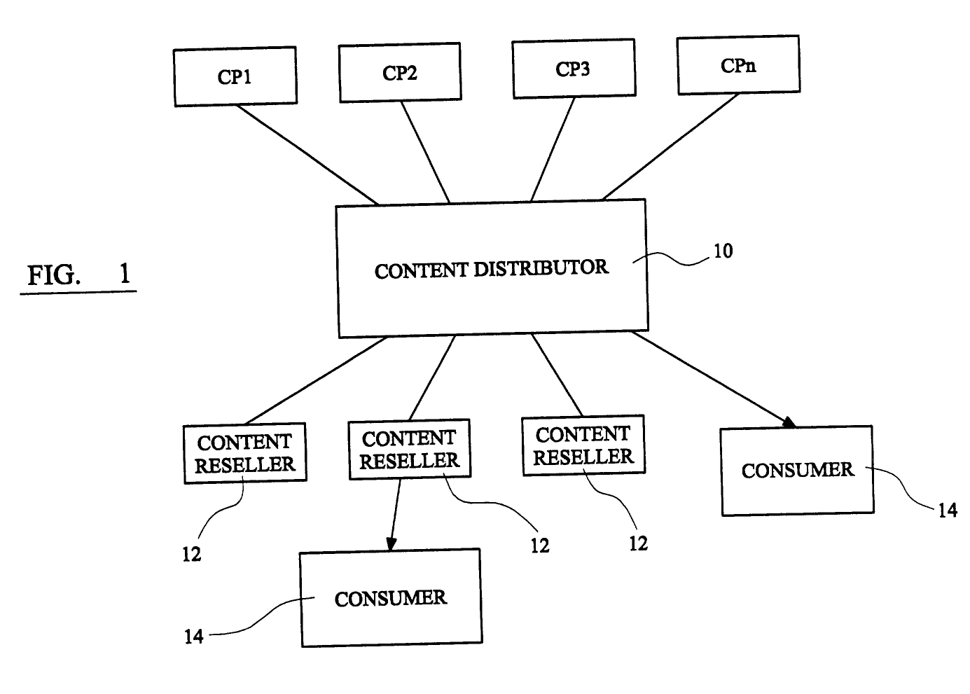

Referring to FIG. 1 of the drawings, in the commercial model envisaged by the present invention, content, such as music, literary or dramatic works, films or other moving images, or indeed any artistic or other work whatsoever which is at some stage converted to electronic form to enable its consumption by a consumer (i.e. “electronic content”) is created by Content Providers CP₁ to CPₙ. The Content Providers CP (which may vary from, for example, a recording artist of world renown to a previously unpublished author) distribute their content through a distributor 10 (such as a record company), who in turn uses content resellers 12 (such as record shops) to sell content to a consumer 14. In some cases, content may also be sold to consumers directly by the content distributor. Generically a person (whether natural or legal) who sells content for money or money's worth is known hereinafter as a commercial distributor, and this term is additionally intended to cover any person acting on behalf or for a commercial distributor (as are any of the other terms used in this specification in connection with parties who perform an act).

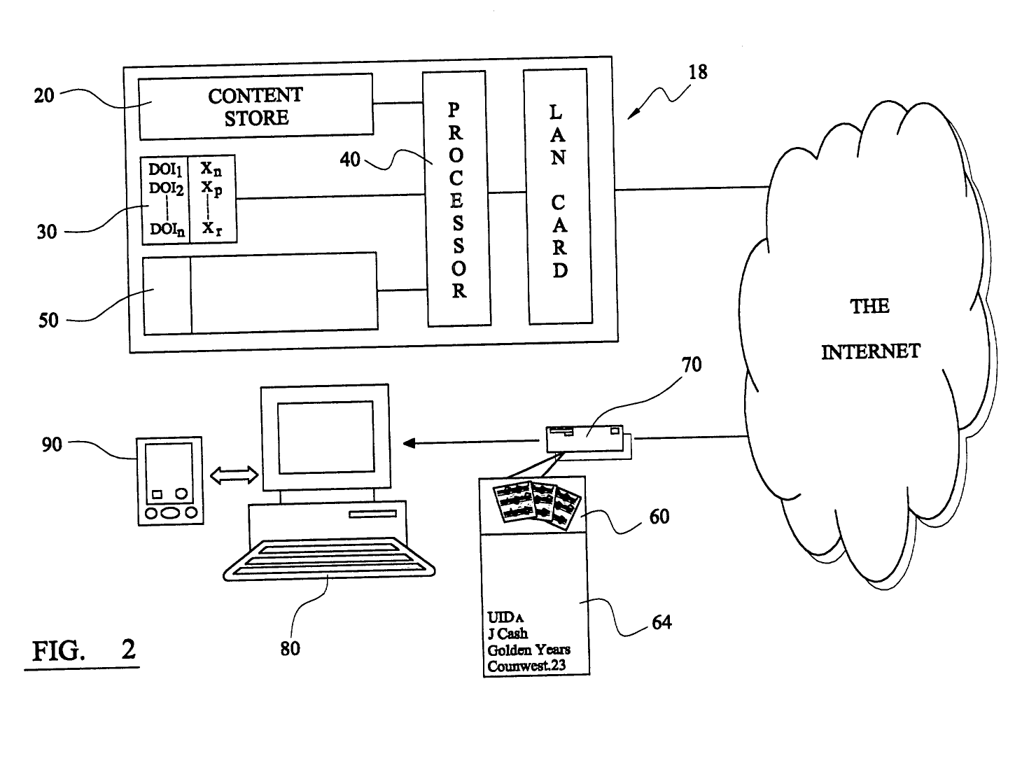

Referring to FIG. 2 of the drawings, a commercial distributor Y stores, manages and distributes content from a server 18. The server 18 includes a first memory 20 in which content is stored, and each piece of content is indexed in the content store by a globally unique identifier, for example, a Digital Object Identifier, known as a DOI, which is globally unique for a given piece of content. Thus all copies of a given piece of content share the same identifier, but different pieces of content will each have a different identifier (e.g. DOI). From the point of view of the commercial distributor Y it is desirable to keep a record of the number of copies of each piece of content that has been sold; using this information, the commercial distributor can keep track of which pieces of content are most popular with their customers. To this end, the server 18 of the commercial distributor Y has a further memory called the content ledger 30, which in the present example is simply a character or character string stored in connection with each DOI, and whose instantaneous value is representative of the number of copies of the content identified by the DOI which have been sold.

In the illustrated example, the content ledger 30 simply stores a number X against each DOI, where X is the number of copies sold. Upon conclusion of a sale of one or more copies of a given piece of content, the processor 40 of the commercial distributor increments the number X, stored against the DOI of the content which has been sold, by the number of copies sold.

The identifier DOIₙ and/or an additional identifier is used in a third element of the memory architecture of server 18, known as the licence bank 50, which is a record of each user registered with the commercial distributor Y, and for each user, a record of all content sold (and licences granted) to that user.

Sale of a piece of content, which in the present example is a song by the artist Johnny Cash, takes place as follows. Once the commercial distributor Y has received either payment, or an undertaking to pay (e.g. the submission of credit card details) for the content from a consumer A, who in the present example is already registered with commercial distributor Y and has the user identification UID_{A}, the processor 40 retrieves a copy of the content from the content store 20. This action automatically causes an incrementation of the number X stored in the content ledger 30 against DOI₂; in the present example, a single copy of DOI₂ has been retrieved, and so X is incremented by 1, to Xₚ. The licence bank 50 is then updated to reflect the purchase of DOI₂ by UID_{A}. Henceforth, therefore, user licence bank 50 will enable commercial distributor Y to determine that user UID_{A} has purchased a copy of DOI₂. In a further modification, the licence bank might also store the time at which the update was made.

Following the update of the licence bank 50, identifiers identifying at least consumer A and the contract under which the content is owned (the contract itself being stored in the licence bank 50) are embedded in the metadata 64 (in this example, the title of the artist, the name of the song, and filename of the file in the content store 20) of the copy of the electronic content 60 just purchased by the user UID_{A}, and the content together with its updated metadata is then bundled into a message 70. The message 70 is sent via the network, which in the present example is the internet, to the consumer A (whose user ID with commercial distributor Y is UID_{A}), who may download the new content 60 including the updated metadata from a desktop computer 80 to a personal digital assistant (PDA) 90.

In a preferred embodiment of the invention, the licence identifier is a separate entity from the globally unique identifier identifying the content itself, so as to maximise the flexibility of the arrangement. As stated above, in the broadest terms, a contract or licence is a mechanism by which permission is granted or authority is conferred, and such a mechanism can take many different forms and grant permission or confer authority for many different things and in many different ways. Thus, for example, a single licence could refer to one or more specific acts permitted to be performed by a single consumer in respect of a single piece or even copy of a piece of content. Another type of licence, may confer authority to a single consumer in respect of all copies of a piece of content, or even all copies of a number of pieces of (possibly related) content, for example, all albums by a particular artist. Alternatively, a consumer could have a single contract which details all of the content owned by that consumer, which licence is updated each time the consumer purchases another piece of content. It is even envisaged that certain groups of consumers could have permission granted thereto or authority conferred thereupon, perhaps upon payment of a subscription fee or fulfilment of certain requirements, say. Thus, it is preferred to provide the licence identifier separately from the globally unique identifier identifying the content within the metadata, because, for example, a user may have a single licence which covers all pieces of content by a particular artist, which would be indicated by a blanket licence which is referenced by a single identifier, as opposed to the relevant licence data being linked with a particular copy of a piece of content.

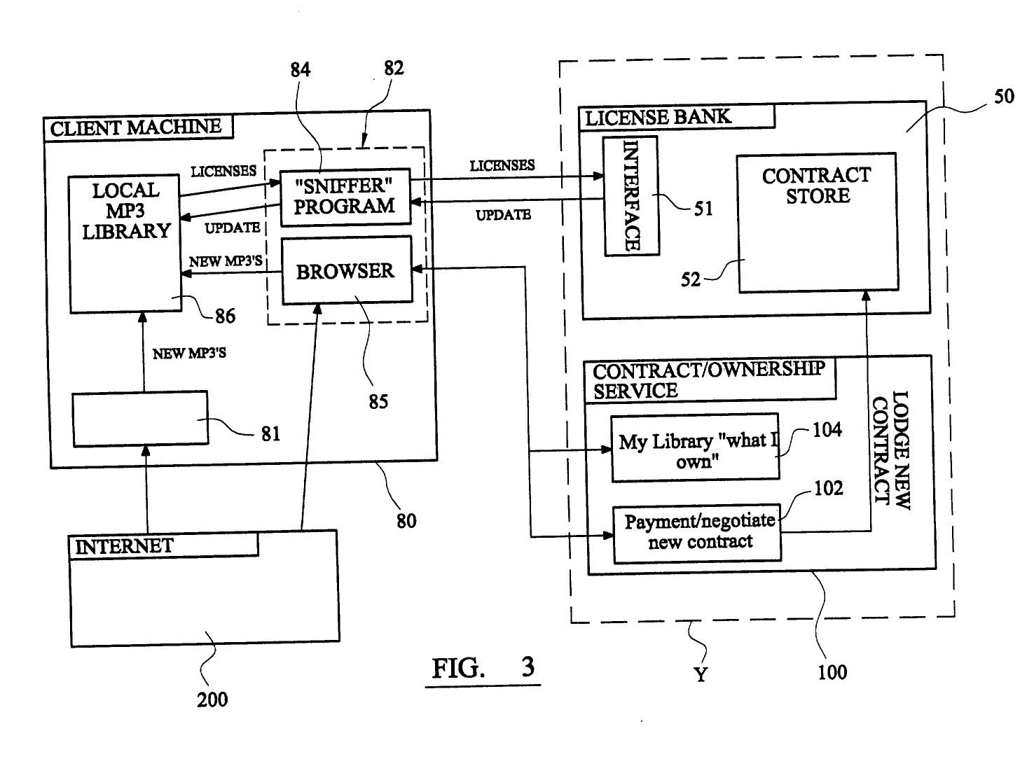

Referring now to FIG. 3 of the drawings, the computer 80 may be connected to the internet via an interface 81, and includes a content management module 82 which runs a “sniffer” program 84 and a browser 85. The “sniffer” program 84 may comprise a plug-in module to a virus scanner (not shown), for example, the virus scanner operating to check all files entering and being opened by the computer 80. Within the computer 80, the “sniffer” program 84 checks the contents of a local MP3 library 86 stored in the user's computer 80, retrieves the licence data embedded in the metadata of all MP3 files stored therein and sends the licence data to a networked contract bank 50 via its interface 51. The licence bank includes means (not shown) for verifying the licence data received from the “sniffer” program 84 against its contents stored in a contract store 52 which includes details of all registered users and the associated contracts already in existence between them and the commercial distributor Y. Preferably, the retrieval, transmission and comparison activities described above are invisible to the user.

In accordance with the method and apparatus of the first aspect of the present invention, content may be legitimately passed directly from one consumer to another, typically by transmitting a complete copy of the content via, for example, e-mail or consumers can obtain copies of electronic content via the Internet 200, for example. In the present example, consumer A has transmitted a copy of a piece of electronic content owned by him to consumer B, and for the purposes of this example, a copy of the content management program 82 is already running on consumer B's computer. However, the content management application is also adapted to transmit a copy of itself to consumer B's computer upon instruction from consumer A, and this would occur prior to the transmission of any content.

Consumer B is now able to consume the content transmitted from consumer A, even though he has not paid for it. The “sniffer” program 84 running on Consumer B's computer 80 either periodically, or in response to some external signal, retrieves all licence data embedded in the metadata of the electronic content stored in the local library 86 and transmits such licence data to the contract bank 50. The licence bank compares the licence data received from the “sniffer” program 84 with the contents of the contract store 52. However, in order to deal with electronic content containing no licence data, such as content recorded from a compact disc, or the like, the “sniffer” program 84 is beneficially arranged to retrieve and transmit not only licence data, but additional metadata to identify at least the content itself and consumer B.

In the case of that licence data received from the “sniffer” program 84 which indicates, when compared with the contents of the licence bank 50, that consumer B owns the content to which it relates, no further action is needed. If, however, the licence data does not correspond with the contents of the contract store 52, there are generally two possible outcomes. In the first event, the received licence data differs in that it relates to content for which consumer B does not own a contract, i.e. the content has not been paid for. In this situation, consumer B is asked if they wish to purchase a genuine copy of the content. Another outcome of the reconciliation process is where consumer B has a genuine licence for a piece of content or group of pieces of content (such as all material by a certain artist), but did not previously have a copy of such licenced content in their library and has been sent a copy of the content by, for example, Consumer A. In this case, the licence bank 50 simply sends updated licence data to the “sniffer” program 84 which updates the local MP3 library 86 by updating the licence data embedded in the electronic content in question with the new owner and an identifier identifying the contract under which they own the content. Of course, if for example the content had simply been recorded from a compact disc or the like, then the associated metadata will contain no licence data at all.

Referring back to the case whereby it is determined that consumer B is holding copies of content which has not been paid for, if he expresses a wish to purchase a genuine copy of the content, the licence bank stores at least some of the original licence data (identifying the content and the originator of the copy thereof) in a temporary cache and the content management program 80 connects consumer B via the browser 85 to a payment/new contract negotiation module 102 (or “service portal”) of a contract/ownership service 100. Consumer B then negotiates and/or agrees to a new contract, pays for it, and then the new contract is lodged in the licence bank 50. In addition, the licence data embedded in the content in question being stored in the local library of consumer B's computer 80 is updated (via the “sniffer” program 84) using data received from the licence bank 50.

The contract/ownership service 100 may also have high capacity storage means 104 for storing all MP3 files owned by all registered users for selective retrieval and use by the users as required. The users may also be able to obtain from the storage means 104 a listing of all MP3 files that they own so that they can choose therefrom which one(s) they wish to retrieve. This means that the user's computer does not require excessively large storage means to store all of the user's owned MP3 files locally. The service 100 may also provide means to allow the user to view one or more of their contracts.

The metadata of the copy of the electronic content in question is then updated, via the “sniffer” program 84, to include new licence data identifying consumer B as the owner and including an identifier of the contract under which consumer B owns their copy of the content.

In the event that the consumer does not agree to pay for the content, the server then asks the consumer if they wish to delete any illegitimate content from their local storage, in this case their PDA and computer. If the user agrees (for example, because he does not like the music which he has received and therefore does not want to pay for it), the licence bank 50 communicates with the content management program 82 and instructs it to delete all copies of that content and all licence data related to it. If the user does not wish to pay, and does not wish to delete any content which has not been paid for, the server 18 operates to deny the user access to their personal content store (described in more detail below) and, possibly following a further warning, cancels their user registration.

Once the transaction with consumer B is concluded, and assuming that consumer B has paid for a contract for the content, the processor 40 of the server 18 then retrieves the stored data from the temporary cache, and sends a message to consumer A including reward points or the like, typically redeemable against further content when sufficient points have been accumulated, and identification of the content the consumer is being rewarded for transmitting.

In a further development, the commercial distributor provides further reward to a consumer in the event that they transmit a copy of the content management program to a consumer who then registers as a user with the commercial distributor.

In another embodiment of the present invention, the comparison/verification process could be achieved by sending from the licence bank 50 to the content management program 82 a list of all content owned by a particular consumer, and then comparing the contents of that user's local library 86 against the list.

A further incentive of registering with the commercial distributor, and therefore engaging in the lawful purchase and ownership of content is the ability to manage content in a more flexible manner as a result of having access to a personal content store held in the server by the commercial distributor on behalf of each of its users, in which all of the content owned by the user is stored. This obviates the need for the user to have to store personally (including the necessity of providing back-up contingency) all content which he or she owns, so that instead the consumer may retrieve from the personal content store held by the server, those pieces of content which they require over any period of time.

Thus, the present invention provides a way of offering a service to consumers, in which incentives are provided for such consumers to use the service, and to pay for the electronic content they obtain. It provides a measure of freedom as it can be set up to encourage and reward distribution, as well as penalising those parties who choose not to pay for their content. The present invention provides a way of determining ownership of any particular piece of content, and in one embodiment of the invention, addresses this issue using a networked licence bank to hold a definitive record of ownership for each consumer, as well as means for embedding that licence (or ownership) information in the content, and a means for validating the licence information embedded in the content with the content of the licence bank. In summary, the present invention provides technical means to allow free copying of material, but also at some point later to recover money to pay for the content, and has the significant advantage, in the case where licence data is embedded in the metadata of the electronic content, that metadata generally (and thus the associated licence data) is very difficult to corrupt, so that fraud by attempting to disguise, for example, a rare (and therefore expensive) piece of music by changing the DOI to that of a more common (and therefore cheaper) piece of music is discouraged if not eliminated altogether. It will be appreciated, however, that the underlying concept of the present invention can be generalised to a wide variety of domains, not just digital media.

In summary, the main advantages of the present invention are perceived to be:

that all stored content can be periodically checked, and not just licence-enabled content;

that it is suitable for use with all current equipment for playing digital content, without modification being required;

it is not necessary to provide specially-adapted copying software in order to facilitate the invention: any distribution scheme can be used(such as e-mail, internet, file sharing, Napster, burning from a compact disc, etc.) because the licence travels with the file.

the system can be adapted to detect all electronic content files, such as MP3 files, stored on a user's computer, such that all files having no licence are immediately brought onto the system;

there is little or no incentive to tamper with either the metadata of the file or the licence; tampering with the metadata is likely to result in all files being renamed, thereby making them difficult to identify for use, and because all local licences are checked against the contents of a licence bank and only have any meaning within the context of the definitive ownership recorded in the licence bank, tampering with the local licences would have little or no effect;

the same technique can be used on multiple devices, such devices being scanned for relevant files, when required.

Content and messages containing content are typically constructed using Simple Object Access Protocol (“SOAP”), which is known per se and which will therefore not be discussed further, and transmitted using Hyper-Text Transfer Protocol, widely known as “http”.

As mentioned above, references in this specification to an act performed by a party is intended to include within its scope the performance of that act by another party on behalf of the first party. References to the sending of data is intended to include where appropriate the sending of a copy of the aforementioned data.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A method of distributing electronic content including digital data (metadata)defining or otherwise identifying said content, the method comprising the steps of:
a) reading the metadata included in a copy of electronic content to identify the content to which it relates;
b) obtaining data relating to the identity of a holder of said copy;
c) determining if said metadata includes licence data (or information identifying such licence data), which licence data relates to the identity of one or more owners or licensees of said content, and if such licence data (or information relating thereto) is determined to be included in said metadata, determining if said holder of said copy is identified therein as an owner or licensee of said content; and, if not:
d) determining if said holder is an owner or licensee of said content and, if not, receiving payment for said copy of said content such that said holder becomes an owner or licensee of said content; and
e) generating or obtaining new licence data for inclusion in said metadata of said copy of said content, said new licence data identifying said holder as an owner or licensee of said content.

2. A method according to claim 1, wherein said new licence data comprises updating data to update existing licence data (or information relating thereto) determined in step c) to be included in said metadata of said copy of said content.

3. A method according to claim 1, wherein said new licence data comprises data to be added to said metadata of said copy of said content.

4. A method according to claim 1, wherein said licence data is embedded in the metadata of the copy of the content to which it relates, and comprises at least information identifying the licensee of said copy of said content and an identifier of a contract under which that copy of the content is owned or licensed.

5. A method according to claim 1, including the steps of providing to a first consumer a first copy of said content, and including in the metadata of said first copy first licence data or information identifying first licence data, said first licence data including data at least relating to the identity of said first consumer as the owner or licensee of said first copy.

6. A method according to claim 5, including the steps of:
i) receiving at least a sufficient portion of the metadata included in a second copy of said content to identify the content to which it relates, said second copy being a substantially identical copy of said first copy and being held by a second consumer;
ii) determining the identity of said second consumer;
iii) determining if said second consumer is an owner or licensee of said content and, if not, receiving payment for said second copy of said content; and
iv) subsequent to determination that said second consumer is an owner or licensee of said content or receipt of payment for said copy, generating or obtaining updating data to update said first licence data (or information relating thereto) included in the metadata of said second copy so as to create second licence data (or information relating thereto) identifying said second consumer as owner or licensee of said second copy of said content.

7. A method according to claim 1, including the steps of:
i) receiving at least a sufficient portion of the metadata included in a second copy of electronic content to identify the content to which it relates, said second copy being a substantially identical copy of a first copy of said content and having no licence data included in its metadata;
ii) determining the identity of the holder of said second copy;
iii) determining if said holder is an owner or licensee of said content and, if not, receiving payment for said second copy of said content; and
iv) subsequent to determination that said holder is an owner or licensee of said content or receipt of payment for said copy, generating or obtaining licence data (or information relating thereto) for inclusion in the metadata of said second copy, said licence data identifying said holder as owner or licensee of said second copy of said content.

8. A method according to claim 1, comprising the steps of checking all content files of one or more predetermined types stored on a first user's computer or similar digital storage means, reading any licence data included therein and/or identifying any stored content having no licence data, determining the identity of said first user, and comparing said licence data against the contents of a licence bank to identify any discrepancies and/or comparing identifying details relating to the identity of said first user against the contents of a licence bank to determine whether said first user is an owner or licensee of said stored content having no licence data.

9. A method according to claim 8, wherein in the event that a piece of content is identified, having licence data which is valid but relates to a second user and/or having no licence data and in respect of which said first user is not an owner or licensee, the method includes the step of offering the first user the opportunity to purchase a legitimate copy of said content.

10. A method according to claim 9, wherein if the first user indicates his desire to purchase a legitimate copy of said content, the method includes the step of directing the user to a service portal or the like to negotiate/agree the terms of a licence, receive payment from the user, and send details of the new licence to said licence bank.

11. A method according to claim 10, wherein, in the case where a copy of said content is transmitted from a second user to said first user, the second user is rewarded if the first user purchases a legitimate copy of said content.

12. A method according to claim 8, wherein the step of checking all content files of one or more predetermined types stored on a first user's computer comprises receiving by a content management means a list of licences owned by said first user, comparing said list against stored content and licence data, and identifying any discrepancies accordingly.

13. Apparatus for distributing electronic content including digital data (metadata) defining or otherwise identifying said content, the apparatus comprising a computing system programmed to:
a) read the metadata included in a copy of electronic content to identify the content to which it relates;
b) obtain data relating to the identity of a holder of said copy;
c) determine if said metadata includes licence data (or information identifying such licence data), which licence data relates to the identity of one or more owners or licensees of said content, and if such licence data (or information relating thereto) is determined to be included in said metadata to determine if said holder of said copy is identified therein as an owner or licensee of said content; and, if not, to determine if said holder is an owner or licensee of said content and, if not to receive payment for said copy of said content such that said holder becomes an owner or licensee of said content; and
d) generate or obtain new licence data for inclusion in said metadata of said copy of said content, said new licence data identifying said holder as an owner or licensee of said content.

14. Apparatus according to claim 13, wherein said new licence data comprises updating data to update existing licence data (or information relating thereto) determined in step c) to be included in said metadata of said copy of said content.

15. Apparatus according to claim 13, wherein said new licence data comprises data to be added to said metadata of said copy of said content.

16. Apparatus according to claim 13, wherein said licence data is embedded in the metadata of the copy of the content to which it relates, and comprises at least information identifying the licensee of said copy of said content and an identifier of a contract under which that copy of the content is owned or licensed.

17. Apparatus according to claim 13, further arranged to provide to a first consumer a first copy of said content, and include in the metadata of said first copy first licence data or information identifying first licence data, said first licence data including data at least relating to the identity of said first consumer as the owner or licensee of said first copy.

18. Apparatus according to claim 17, further arranged to:
i) receive at least a sufficient portion of the metadata included in a second copy of said content to identify the content to which it relates, said second copy being a substantially identical copy of said first copy and being held by a second consumer;
ii) determine the identity of said second consumer;
iii) determine if said second consumer is an owner or licensee of said content and, if not, receive payment for said second copy of said content; and
iv) subsequent to determination that said second consumer is an owner or licensee of said content or receipt of payment for said copy, to generate or obtain updating data to update said first licence data (or information relating thereto) included in the metadata of said second copy so as to create second licence data (or information relating thereto) identifying said second consumer as owner or licensee of said second copy of said content.

19. Apparatus according to claim 13, further arranged to:
i) receive at least a sufficient portion of the metadata included in a second copy of electronic content to identify the content to which it relates, said second copy being a substantially identical copy of a first copy of said content and having no licence data included in its metadata;
ii) determine the identity of the holder of said second copy;
iii) determine if said holder is an owner or licensee of said content and, if not, receive payment for said second copy of said content; and
iv) subsequent to determination that said holder is an owner or licensee of said content or receipt of payment for said copy, generate or obtain licence data (or information relating thereto) for inclusion in the metadata of said second copy, said licence data identifying said holder as owner or licensee of said second copy of said content.

20. Apparatus according to claim 13, further arranged to check all content files of one or more predetermined types stored on a first user's computer or similar digital storage means, read any licence data included therein and/or identify any stored content having no licence data, determine the identity of said first user, and compare said licence data against the contents of a licence bank to identify any discrepancies and/or to compare identifying details relating to the identity of said first user against the contents of a licence bank to determine whether said first user is an owner or licensee of said stored content having no licence data.

21. Apparatus according to claim 20, further arranged to offer the first user the opportunity to purchase a legitimate copy of said content, in the event that a piece of content is identified having licence data which is valid but relates to a second user and/or having no licence data and in respect of which said first user is not an owner or licensee.

22. Apparatus according to claim 21, further arranged to direct the user to a service portal or the like to negotiate/agree the terms of a licence, receive payment from the user, and send details of the new licence to said licence bank, if the first user indicates his desire to purchase a legitimate copy of said content.

23. Apparatus according to claim 22, wherein, in the case where a copy of said content is transmitted from a second user to said first user, the second user is rewarded if the first user purchases a legitimate copy of said content.

24. Apparatus according to claim 20, arranged to check all content files of one or more predetermined types stored on a first user's computer by receiving by a content management means a list of licences owned by said first user, comparing said list against stored content and licence data, and identifying any discrepancies accordingly.

25. Apparatus according to claim 23, comprising a “sniffer” program or the like for retrieving, either periodically or in response to an external signal, licence data embedded within electronic content stored on a user's computer or other digital storage means and providing said licence data to said comparison means.

26. Computer software for programming the apparatus of claim 13.

27. A method of storing electronic content comprising the steps of recording said electronic content on a data storage medium, generating metadata identifying said content and storing said metadata on said data storage medium, said metadata including a storage area for storing licence data (or information relating to licence data) for identifying one or more users as owners or licensees of said content in such a way as to be capable of being altered, added to or replaced using the method of claim 1 or by apparatus according to claim 13.

28. Apparatus for distributing electronic content including digital data (metadata) defining or otherwise identifying said content, the apparatus comprising a computer system programmed to:
a) receive or obtain data identifying a piece of content;
b) receive or obtain data relating to the identity of a holder of a copy of said content;
c) obtain access to or store a licence bank comprising details of licences owned by each of a plurality of users, which licence bank can be searched to determine whether or not said holder owns a licence for said content;
d) provide, or direct a user to, a portal, by means of which new licences can be negotiated, agreed or issued as required;
e) update said licence bank in the event that a new licence is issued; and
f) provide details of said new licence for use in generating licence data to be written to the metadata of said copy of said content.

29. Apparatus according to claim 28, wherein said licence bank and/or portal is run on one or more servers.

30. Apparatus according to claim 29, wherein at least one of said servers has access to a content store for storing a plurality of pieces of content.

31. Apparatus according to claim 30, wherein each of the pieces of content stored in said content store is identified by a globally unique identifier.

32. Computer software for programming the apparatus of claim 28.

33. A method for distributing electronic content including digital data (metadata) defining or otherwise identifying said content, the method comprising the steps of:
a) providing a licence bank in which is stored details of licences owned by each of a plurality of users;
b) searching said licence bank to determine whether or not a specified user owns a licence for a particular piece of content;
c) providing, or directing a user to, a portal, by means of which new licences can be negotiated, agreed or issued as required;
e) updating said licence bank in the event that a new licence is issued; and
f) providing details of said new licence for use in generating licence data to be written to the metadata of said copy of said content.
